(19) United States
(12) Patent Application Publication
(10) Pub. No.: US 2015/0255119 A1
(43) Pub. Date: Sep. 10, 2015

(54) DISPLAY APPARATUS AND METHOD FOR EDITING AND DISPLAYING RECORDED VIDEO CONTENT

(71) Applicant: SAMSUNG ELECTRONICS CO., LTD., Suwon-si (KR)

(72) Inventor: Jae-ho HONG, Yongin-si (KR)

(73) Assignee: SAMSUNG ELECTRONICS CO., LTD., Suwon-si (KR)

(21) Appl. No.: 14/476,923

(22) Filed: Sep. 4, 2014

(30) Foreign Application Priority Data
Mar. 6, 2014 (KR) 10-2014-0026652

(51) Int. Cl. G11B 27/034; H04N 5/76

(52) U.S. Cl. CPC G11B 27/034; H04N 5/7605

(57) ABSTRACT

A display apparatus and a method for editing and displaying recorded video content are provided. The method for editing recorded video content in a display apparatus includes receiving an input of an edit command for a specific frame section of the video content, generating an indexing packet to indicate the edit command for the specific frame section through extraction of information of the specific frame section for which the edit command is input, and storing a transport stream for the video content, the index packet being inserted to the transport stream. Accordingly, the display apparatus can accurately edit the video frame section that corresponds to the image selected by the user, and can reduce a blocking phenomenon that occurs during the editing.

### PRIORITY

This application claims priority under 35 U.S.C. §119(a) to Korean Patent Application No. 10-2014-0026652, filed on Mar. 6, 2014, in the Korean Intellectual Property Office, the disclosure of which is incorporated herein by reference.

### BACKGROUND

1. Field

The present disclosure relates to a display apparatus and a method thereof, and more particularly to a display apparatus and a method for editing and displaying recorded video content.

2. Description of the Related Art

In general, a display apparatus having a PVR (Personal Video Recorder) can record or store video content provided from a sky wave TV, a cable TV, or a satellite, or can edit a specific section of recorded video content using a storage medium such as a HDD (Hard Disk Drive).

In particular, in the case of editing a specific section of recorded video content, a display apparatus in the related art performs editing of a specific frame section that is requested by a user based on a read pointer of a video frame at a time point selected by the user in relation to the corresponding video content and an amount of data of remaining video frames that are temporarily stored in a buffer without being decoded.

As described above, according to the method for editing recorded video content in the related art, since the edited section is determined based on the currently decoded video frame and the amount of data of the remaining video frames that are not decoded, correct editing may not be performed with respect to the section that is selected by the user.

That is, in the case of performing the method for editing recorded video content in the related art, a start video frame and a last video frame included in the edited section may be video frames that are before or after the video frame selected by the user. Accordingly, in the case of performing the editing method in the related art, editing may be performed on a video frame that the user does not want to edit, or the editing may not be performed on a video frame that the user wants to edit.

### SUMMARY

The present disclosure has been made to address at least the above needs and to provide at least the advantages described below, and an aspect of the present disclosure is to accurately edit a section of recorded video content that is selected by a user.

Another aspect of the present disclosure is to display edited video content more naturally.

According to one aspect of the present disclosure, a method for editing recorded video content in a display apparatus includes receiving an input of an edit command for a specific frame section of the video content; generating an indexing packet to indicate the edit command for the specific frame section through extraction of information of the specific frame section for which the edit command is input; and storing a transport stream for the video content, the index packet being inserted to the transport stream.

The generating may include extracting time information of the specific frame section through acquiring of PTS (Presentation Time Stamp) information of video frames included in the specific frame section for which the edit command is input.

The generating may include acquiring the time information of the specific frame section through acquiring of PTS information of a start video frame and PTS information of a last video frame of the video frames included in the specific frame section for which the edit command is input.

The generating may include generating an ES (Elementary Stream) packet including a reserved start code that indicates the edit command and PTS information of a start video frame and a last video frame included in the specific frame section; generating a PES (Packetized Elementary Stream) packet based on the ES packet; and generating the indexing packet in consideration of the PES packet as at least one TS packet having a preset unit size.

The storing may include inserting the indexing packet before the specific frame section for which the edit command is input, and then storing the video content in which the indexing packet is inserted.

According to another aspect of the present disclosure, a display apparatus includes a storage configured to store video content; an input unit configured to receive an input of an edit command for a specific frame section of the video content; and a controller configured to generate an indexing packet to indicate the edit command for the specific frame section through extraction of information of the specific frame section for which the edit command is input and to store the indexing packet through insertion of the indexing packet in a transport stream for the video content.

The controller may extract time information of the specific frame section through acquiring of PTS (Presentation Time Stamp) information of video frames included in the specific frame section for which the edit command is input.

The controller may acquire the time information of the specific frame section through acquiring of PTS information of a start video frame and PTS information of a last video frame of the video frames included in the specific frame section for which the edit command is input.

The controller may generate an ES (Elementary Stream) packet including a reserved start code that indicates the edit command and PTS information of a start video frame and a last video frame included in the specific frame section, generate a PES (Packetized Elementary Stream) packet based on the ES packet, and generate the indexing packet in consideration of the PES packet as at least one TS packet having a preset unit size.

The controller may insert the indexing packet before the specific frame section for which the edit command is input, and the storage may store the video content in which the indexing packet is inserted.

According to still another aspect of the present disclosure, a method for displaying recorded video content in a display apparatus includes decoding a transport stream of video content including an indexing packet that indicates an edit command for a specific frame section of the video content; and displaying the video content while editing the specific frame section based on the indexing packet.

The method for displaying recorded video content according to the aspect of the present disclosure may further include extracting a packet including a reserved start code that indicates the edit command from the transport stream as the indexing packet before the decoding.

The decoding may include decoding I picture frames (Intra picture) among video frames included in the specific frame section based on PTS information included in the indexing packet.

The displaying may include acquiring time information of a start video frame and time information of a last video frame included in the specific frame section based on PTS information included in the indexing packet, and displaying the video content while editing the specific frame section based on the acquired time information.

The displaying may include displaying the start video frame or a previous video frame included in the specific frame section while editing the specific frame section.

According to still another aspect of the present disclosure, a display apparatus for displaying recorded video content includes a decoder configured to decode a transport stream of video content including an indexing packet that indicates an edit command for a specific frame section of the video content; a display configured to display the decoded video content; and a controller configured to control the display to display the video content while editing the specific frame section based on the indexing packet.

The controller may determine whether there is a packet including a reserved start code that indicates the edit command with reference to headers of packets constituting the transport stream, and then control the decoder to decode the transport stream of the video content.

The controller may instruct the decoder to decode I picture frames (Intra picture) among video frames included in the specific frame section based on PTS information included in the indexing packet.

The controller may acquire time information of a start video frame and time information of a last video frame included in the specific frame section based on PTS information included in the indexing packet, and control the display to display the video content while editing the specific frame section based on the acquired time information.

The controller may control the display to display the start video frame or a previous video frame included in the specific frame section while editing the specific frame section.

As described above, according to various embodiments of the present disclosure, the display apparatus can accurately edit the video frame section that corresponds to the image selected by the user, and can reduce a blocking phenomenon that occurs during the editing.

### BRIEF DESCRIPTION OF THE DRAWINGS

The above and other aspects, features and advantages of the present disclosure will be more apparent from the following detailed description when taken in conjunction with the accompanying drawings, in which:

FIG. 1 is a block diagram of a display apparatus according to an embodiment of the present disclosure;

FIG. 2 is a diagram exemplifying a case where a display apparatus according to an embodiment of the present disclosure generates an indexing packet that indicates an edit command for a specific frame section;

FIG. 3 is a diagram exemplifying a case where edited video content in which an indexing packet is inserted is displayed according to an embodiment of the present disclosure;

FIG. 4 is an exemplary diagram illustrating the structure of an index packet according to an embodiment of the present disclosure;

FIG. 5 is a flowchart illustrating a method for editing recorded video content in a display apparatus according to an embodiment of the present disclosure; and

FIG. 6 is a flowchart illustrating a method for displaying video content in which an indexing packet is inserted in a display apparatus according to an embodiment of the present disclosure.

### DETAILED DESCRIPTION

Hereinafter, embodiments of the present disclosure are described in detail with reference to the accompanying drawings.

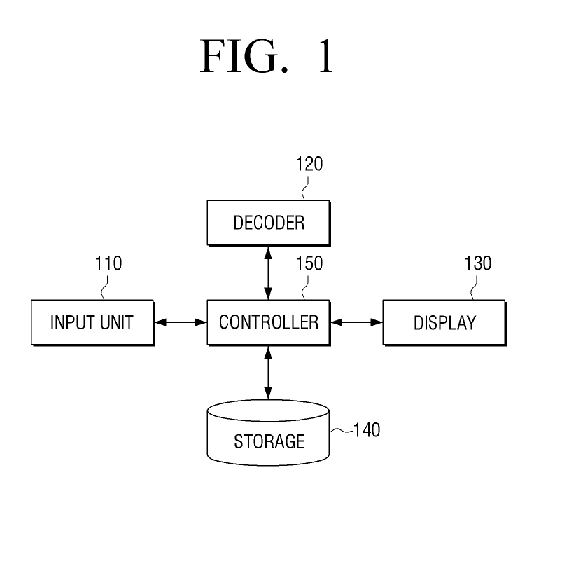

FIG. 1 is a block diagram of a display apparatus according to an embodiment of the present disclosure.

As illustrated in FIG. 1, a display apparatus may be an apparatus having a PVR (Personal Video Recorder) function that can record and reproduce an image received from an outside, such as a smart phone, a tablet PC, and a smart TV.

The display apparatus includes an input 110, a decoder 120, a display 130, a storage 140, and a controller 150.

The input 110 receives a user command, which is inputted from an input means, such as an operation unit (not illustrated) or a touch panel (not illustrated), provided on the display apparatus or which is input from a wireless input means, such as a remote controller, and transmits the received user command to the controller 150. According to an embodiment, the input 110 may receive a reproduction command for recorded video content or an edit command for video content being reproduced. Here, the edit command may be a deletion command for a specific video section of the video content being reproduced. In addition, the input unit 110 may receive an input of a control command for controlling the operation of the display apparatus.

The decoder 120 performs decoding of a transport stream of video content that is received from an external device in real time or pre-stored in the storage 140, and the display 130 displays the decoded video content. According to an embodiment, the storage 140 in which the recorded video content is stored may be a storage medium, such as a hard disk drive, a flash memory, a CD, or a DVD.

The controller 150 controls the whole operation of respective configurations of the display apparatus. In particular, if a reproduction command for the video content that is stored in the storage 140 is input through the input 110, the controller 150 may control the decoder 120 and the display 130 to decode the transport stream of the corresponding video content and to display the decoded video content.

Specifically, if the reproduction command for the video data stored in the storage 140 is input, the controller 150 temporarily stores the video frame in the unit of a PES (Packetized Elementary Stream) packet that constitutes the transport stream of the corresponding video content in a buffer (not illustrated). Here, the transport stream may be a video stream that is separated through a demultiplexer (not illustrated). If the video frame in the unit of a PES packet is temporarily stored in the buffer (not illustrated), the controller 150 extracts PTS (Presentation Time Stamp) information included in headers of respective video frames temporarily stored in the buffer (not illustrated). Here, the PTS information is time information at which reproduction of the video frame starts. Accordingly, the controller 150 determines a time point when a plurality of video frames that are temporarily stored in the buffer (not illustrated) are decoded on the basis of the PTS information by video frames, and controls the decoder 120 to decode the video frame that corresponds to the determined time point. Accordingly, the decoder 120 can perform decoding of the video frame that is temporarily stored in the buffer (not illustrated) based on the control command.

On the other hand, the controller 150 generates a reference clock for outputting a video frame and an audio frame of the corresponding video content at a synchronized time point, and transmits the generated reference clock information and the PTS information extracted by video frames to the display 130. Accordingly, the display 130 can display the video frame that is decoded through the decoder 120 based on the reference clock information and the PTS information.

On the other hand, the user can edit a partial section of the video content that is reproduced through the display 130. Here, the editing of the partial section means editing of the corresponding section on the screen. That is, a user may select a section of the video content that is currently reproduced of which the viewing is determined to be unnecessary, may request editing of the selected section. As described above, if an edit command for the section selected by the user is input through the input unit 110 in a state where the video content is reproduced through the display 130, the controller 150 extracts information of a specific frame section for which the edit command is input and generates an indexing packet that indicates the edit command for the corresponding specific frame section. Thereafter, the controller 150 inserts the indexing packet that is generated to indicate the edit command for the specific frame section into the transport stream of the corresponding video content, and stores the video content in the storage 140.

Specifically, if the edit command is input through the input unit 110, the controller 150 may acquire the PTS information of the video frame included in the specific frame section for which the edit command is input, and may extract the time information of the specific frame section based on the acquired PTS information. More specifically, if the edit command is input through the input unit 110, the controller 150 may extract the time information of the specific frame section through acquiring of PTS information of a start video frame and PTS information of a last video frame of the video frames included in the input specific frame section.

As described above, if the PTS information of the start video frame and the last video frame included in the specific frame section for which the edit command is input is acquired, the controller 150 generates an ES (Elementary Stream) packet that includes a reserved start code that indicates the edit command and the PTS information of the start video frame and the last video frame included in the specific frame section. Thereafter, the controller 150 may generate a PES packet based on the generated ES packet and then may generate the indexing packet in consideration of the generated PES packet as at least one TS (Transport Stream) packet having a preset unit size.

Hereinafter, an operation of generating the indexing packet that indicates the edit command for the specific frame section in the display apparatus according to the present disclosure will be described in detail.

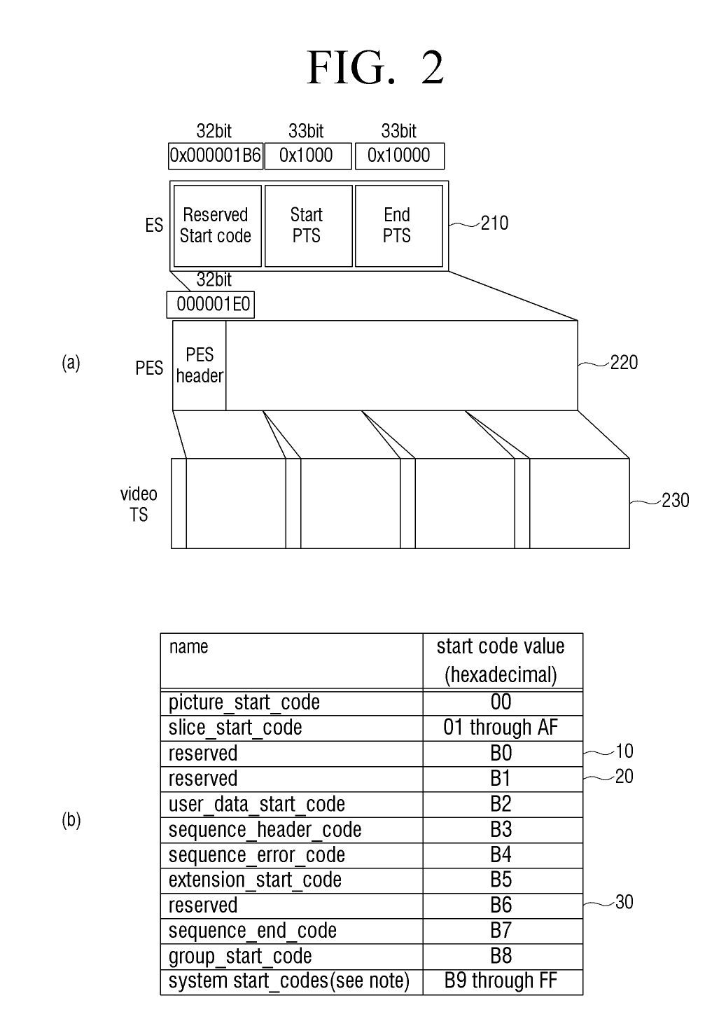

FIG. 2 is a diagram exemplifying a case where a display apparatus according to an embodiment of the present disclosure generates an indexing packet that indicates an edit command for a specific frame section.

As illustrated in (a) of FIG. 2, the controller 150 generates an ES packet 210 that includes a reserved start code that indicates an edit command and PTS information of a start video frame and a last video frame included in a specific frame section. Here, the reserved start code is information for guiding a start of an indexing packet that indicates the edit command for the specific frame section.

Specifically, as illustrated in (b) of FIG. 2, the controller 150 may determine one of reserved start codes 10 to 30 that are not predefined among start codes prescribed by MPEG-2 video standards as a code that indicates the edit command. For example, if the reserved start code 30 is determined as a code that indicates the edit command, the controller 150 may generate the ES packet 210 that includes the reserved start code 30 of 0x000001B6 (32 bits), start PTS information of a start video frame and end PTS information of a last video frame included in the specific frame section. Here, the start PTS information and the end PTS information may be composed of 33 bits.

If the ES packet 210 is generated as described above, the controller 150 generates a PES packet 220 based on the generated ES packet 210. Specifically, the controller 150 may generate a PES packet 220 that includes a PES header including the reserved start code 30 included in the ES packet 210 and a code of 000001E0, and PES payloads including the start PTS information of the start video frame and the end PTS information of the last video frame included in the specific frame section. If the PES packet 220 is generated as described above, the controller 150 generates the PES packet 220 as a TS packet 230 having a preset unit size. Specifically, the controller 150 may generate the TS packet 230 of 188 bytes, which includes a TS header including video PID information and TS payloads included in the PES packet 220.

If the indexing packet in the form of a TS packet is generated as described above, the controller 150 inserts the indexing packet that indicates the edit command for the specific frame section onto the transport stream of the corresponding video content. In this case, it is preferable that the controller 150 inserts the indexing packet that indicates the edit command for the specific frame section before the corresponding specific frame section. According to an exemplary embodiment, the controller 150 may insert the indexing packet between a GOP (Group of Picture) that includes the start video frame included in the specific frame section and a previous GOP. Here, the GOP is a unit group that is composed of a plurality of video frames including I picture frames (Intra picture), P picture frames (Predictive picture), and B picture frames (Bidirectionally predictive picture) in the digital video compression technology, such as MPEG or H.264.

As described above, if the indexing packet is inserted before the specific frame section, the controller 150 stores the transport stream of the video content into which the indexing packet is inserted in the storage 140. Accordingly, the storage 140 may store original first video content and second video content (hereinafter referred to as “edited video content”) into which the indexing packet is inserted in relation to the corresponding video content.

Hereinafter, an operation of displaying edited video content, into which the indexing packet that indicates the edit command for the specific frame section in a display apparatus is inserted, will be described in detail.

As described above, the storage 140 may store recorded video content and edited video content related to the corresponding video content. As described above, the edited video content is video content that includes the indexing packet indicating the edit command for the specific frame section.

If a reproduction command for the edited video content stored in the storage 140 is input through the input unit 110, the controller 150, as described above, may control the decoder 120 and the display 130 to decode the transport stream of the corresponding edited video content and to display the decoded video content.

Specifically, if the reproduction command for the edited video content stored in the storage 140 is input, the controller 150 temporarily stores the video frame in the unit of a PES (Packetized Elementary Stream) packet that constitutes the transport stream of the corresponding edited video content in a buffer (not illustrated). Here, the transport stream may be a video stream that is separated through a demultiplexer (not illustrated). If the video frame in the unit of a PES packet is temporarily stored in the buffer (not illustrated), the controller 150 determines whether the reserved start code that indicates the edit command is included in the video frame with reference to the PES header of the video frame temporarily stored in the buffer (not illustrated). If the reserved start code is not included as the result of the determination, the controller 150 controls the decoder 120 to decode the corresponding video frame based on the PTS (Presentation Time Stamp) information included in the PES header of the video frame that is temporarily stored in the buffer (not illustrated). Accordingly, the decoder 120 may perform decoding of the video frame that is temporarily stored in the buffer (not illustrated) based on the control command.

On the other hand, the controller 150 generates a reference clock for outputting a video frame and an audio frame of the corresponding video content at a synchronized time point, and transmits the generated reference clock information and the PTS information extracted by video frames to the display 130. Accordingly, the display 130 can display the video frame that is decoded through the decoder 120 based on the reference clock information and the PTS information.

On the other hand, if the reserved start code that indicates the edit command is included in the PES header of one of the plurality of video frames that are temporarily stored in the buffer (not illustrated), the controller 150 determines that the corresponding video frame is the indexing packet that indicates the edit command for the specific frame section. Accordingly, if the indexing packet that indicates the edit command for the specific frame section is detected, the controller 150 acquires the start PTS information of the start video frame and the end PTS information of the last video frame included in the specific frame section.

Thereafter, the controller 150 determines the video frame having the PTS information that corresponds to the start PTS information and the end PTS information as the specific frame section for which the editing operation is performed through comparison of the start PTS information and the end PTS information acquired from the indexing packet with the PTS information extracted from the remaining video frames temporarily stored in the buffer (not illustrated).

As described above, if the specific frame section is determined on the basis of the start PTS information and the end PTS information acquired from the indexing packet, the controller 150 controls the decoder 120 to decode only the I picture frames (Inter picture) among the video frames included in the corresponding specific frame section. Further, the controller 150 controls the display 130 to display the edited video content while editing the specific frame section based on time information of the start video frame and time information of the last video frame included in the specific frame section. Here, the editing of the specific frame section may be a deletion of the specific frame section.

Accordingly, the display 130 may display the remaining edited video content while editing the specific frame section of the edited video content. That is, while editing the specific frame section, the display 130 may continuously display the start video frame included in the specific frame section or the previous video frame of the start video frame.

According to an embodiment, if the video frame (hereinafter referred to as the “start video frame”) having the PTS information that corresponds to the PTS information acquired from the indexing packet is acquired, the controller 150 controls the display 130 to display the corresponding video frame. Thereafter, if the video frame (hereinafter referred to as the “last video frame”) having the PTS information that corresponds to the end PTS information acquired from the indexing packet, the controller 150 controls the display to display the video frame of the remaining edited video content from the corresponding video frame. Accordingly, the display 130 continuously displays the start video frame that corresponds to the start PTS information until the last video frame that corresponds to the end PTS information is displayed. Accordingly, the display 130 may edit the video frame between the start video frame that corresponds to the start PTS information and the last video frame that corresponds to the end PTS information, and then may display the remaining edited video content.

On the other hand, if the start video frame that corresponds to the start PTS information included in the indexing packet is acquired as described above, the controller 150 controls the decoder 120 to decode only the I picture frames of the video frame until the last video frame that corresponds to the end PTS information included in the indexing packet is acquired. Accordingly, the decoder 120 decodes the video frame for the I picture frames among the video frames until the last video frame that corresponds to the end PTS information is acquired, decodes the video frame for I picture frames and P picture (Predictive picture) frames in the GOP including the end PTS information, and does not decode the video frame for B picture (Bidirectionally predictive picture) frames.

Here, the I picture frame is a frame that can be decoded using only pixels in the video frame without performing motion compensation predictive coding between other video frames. Further, the P picture frame is a unidirectional predictive frame, and the motion compensation predictive coding between video frames can be performed with reference to the previous I picture frame or P picture frame. Last, the B picture frame is a bidirectionally predictive frame, and motion compensation predictive coding can be performed in front, rear, and both directions with reference to I picture frame or P picture frame that is positioned before the B picture frame or with reference to the I picture frame or P picture frame that is positioned before and after B picture frame.

As described above, since the decoder 120 decodes only the I picture frames among the video frames until the last video frame that corresponds to the end PTS information is acquired, the time, which is required until the last video frame that corresponds to the end PTS information is displayed after the start video frame that corresponds to the start PTS information is displayed, can be minimized, and the blocking phenomenon, which occurs in the process of sequentially displaying the start video frame that corresponds to the start PTS information and the last video frame that corresponds to the end PTS information, can be reduced.

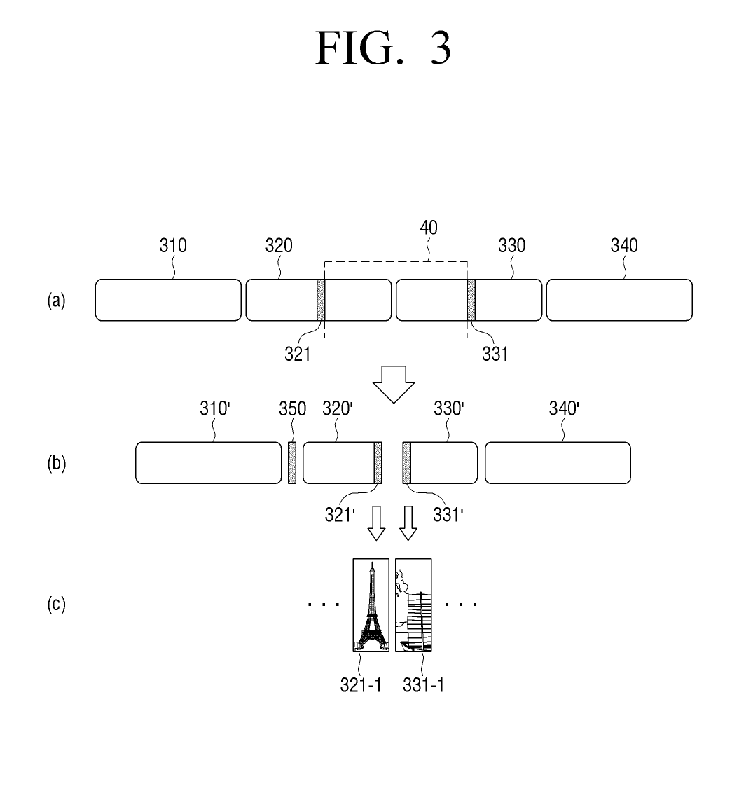

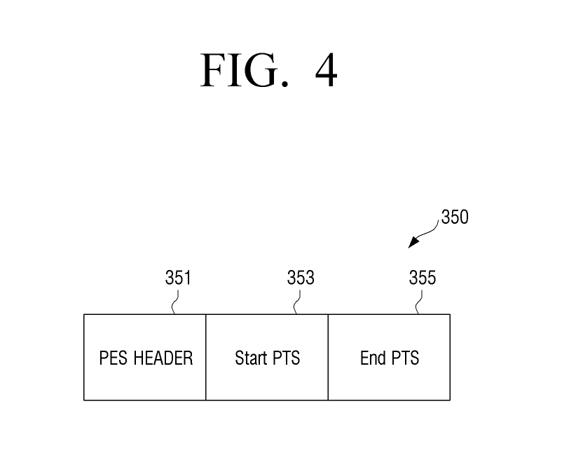

FIG. 3 is a diagram exemplifying a case where the edited video content in which an indexing packet is inserted is displayed according to an embodiment of the present disclosure, and FIG. 4 is an exemplary diagram illustrating the structure of an index packet according to an embodiment of the present disclosure.

In FIG. 3, (a) illustrates grouping of a plurality of video frames constituting the transport stream of the recorded original video content pre-stored in the storage 140 in the unit of first to fourth GOPs 310 to 340. Further, (b) of FIG. 3 illustrates grouping of a plurality of video frames constituting the transport stream of the edited video content into which the indexing packet is inserted to perform the edit command for the specific frame section in relation to the corresponding content in the unit of first to fourth GOPs 310′ to 340′.

First, as shown in (a) of FIG. 3, if the edit command is input for a first video frame included in the second GOP 320 and a second video frame 331 included in the third GOP 330 among the first to fourth GOPs 310 to 340, the controller 150 determines the section between the first video frame 321 and the second video frame 331 as a specific frame section 40 to perform the editing operation. That is, the controller 150 determines the specific frame section 40 between the first video frame 321 and the second video frame 331 as the section to perform a deletion operation.

Accordingly, the controller 150 generates the start PTS information and the end PTS information based on the PTS information of the first video frame 321 and the second video frame 331. Thereafter, the controller 150 generates the indexing packet 350 that includes the reserved start code that indicates the edit command, the start PTS information, and the end PTS information.

As illustrated in FIG. 4, the indexing packet 350 is composed of a PES header 351 and PES payloads 353 and 355, and the reserved start code that indicates the edit command may be included in the PES header 351. Further, the start PTS information that is generated on the basis of the PTS information of the first video frame 321 and the end PTS information that is generated on the basis of the PTS information of the second video frame 331 may be included in the PES payloads 353 and 355.

If the indexing packet 350 is generated, the controller 150, as illustrated in (b) of FIG. 3, inserts the indexing packet 350 between the first and second GOPs 310′ and 320′. Thereafter, if the reproduction command for the edited video content, into which the indexing packet 350 is inserted, is input, the controller 150 determines the corresponding packet as a packet that indicates the edit command for the specific frame section with reference to the PES header of the indexing packet 350 inserted between the first and second GOPs 310′ and 320′. Thereafter, the controller 150 determines the first video frame 321′ included in the second GOP 320′ as the start video frame of the specific frame section based on the start PTS information included in the indexing packet 350. If the start video frame of the specific frame section is determined as described above, the controller 150 controls the display 130 to continuously display the image of the start video frame.

That is, the controller 150 controls the display 130 to display the first video frame 321′ until the second video frame 331′ included in the third GOP 330′ is displayed on the basis of the end PTS information included in the indexing packet 350. Thereafter, if the second video frame 331′ included in the third GOP 330′ is detected on the basis of the end PTS information included in the indexing packet 350, the controller 150 controls the display 130 to display the detected second video frame 331′. Accordingly, as shown in (c) of FIG. 3, the display 130 continuously displays the first image 321-1 that is decoded in relation to the first video frame 321′ until the second image 331-1 that is decoded in relation to the second video frame 331′ is displayed.

On the other hand, the controller 150 may control the decoder 120 to decode the I picture frames among the video frames between the first video frame 321′ and the second video frame 331′ until the second video frame 331′ included in the third GOP 330′ is detected on the basis of the end PTS information included in the indexing packet 350. In accordance with the control command as described above, the decoder 120 decodes the video frame for I picture frame among the video frames between the first video frame 321′ and the second video frame 331′, decodes the video frame for I picture frames and P picture frames in the third GOP 330′, and does not decode the video frame for B picture frames.

According to the present disclosure, it is described that the indexing packet to indicate the edit command for the specific video frame is generated, and the edit operation is performed with respect to the specific video frame section of the video content based on the generated indexing packet. However, the present disclosure is not limited thereto. An indexing packet to indicate a mute command for a specific audio frame that corresponds to a corresponding specific video frame may be generated on the basis of the above-described operation, and a mute operation for the specific audio frame section of the video content may be performed on the basis of the generated indexing packet.

Hereinafter, a method for generating an indexing packet to indicate an edit command for a specific frame section selected by a user among recorded video content and performing an editing operation of the specific frame section based on the generated indexing packet in a display apparatus according to the present disclosure will be described in detail.

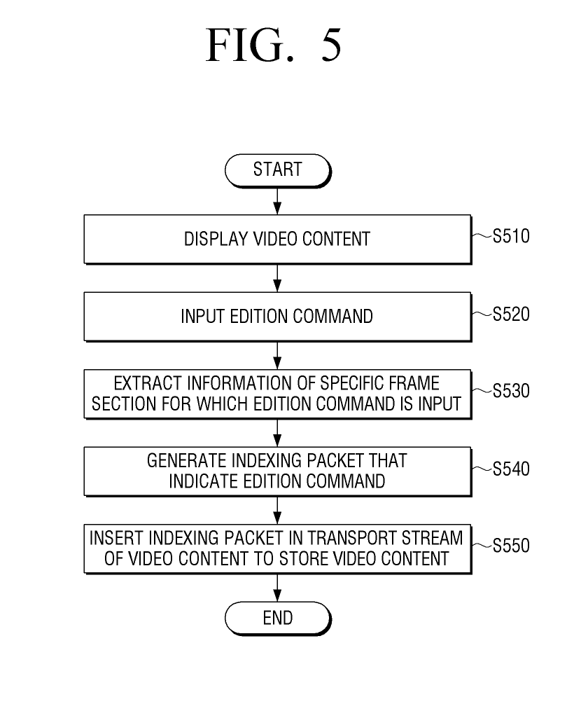

FIG. 5 is a flowchart illustrating a method for editing recorded video content in a display apparatus according to an embodiment of the present disclosure.

As illustrated in FIG. 5, a display apparatus performs decoding of a transport stream of pre-stored video content according to a user command, and then displays the video content based on the decoded transport stream (S510).

On the other hand, a user may edit a partial section of the video content that is reproduced through the display apparatus. Here, the editing of the partial section means editing the corresponding section on the screen. Accordingly, if an edit command for the section selected by the user is input in a state where the video content is displayed, the display apparatus extracts information of a specific frame section that corresponds to the input edit command, and generates an indexing packet that indicates the edit command for the corresponding specific frame section (S520 and S530). Thereafter, the display apparatus inserts the indexing packet that is generated to indicate the edit command for the specific frame section into the transport stream of the corresponding video content to store the video content (S540).

Specifically, if the edit command is input, the display apparatus may acquire the PTS information of the video frame included in the specific frame section for which the edit command is input, and may extract time information of the specific frame section based on the acquired PTS information. More specifically, if the edit command is input, the display apparatus may extract the time information of the specific frame section through acquiring of PTS information of a start video frame and PTS information of a last video frame among video frames included in the input specific frame section.

As described above, if the PTS information of the start video frame and the last video frame included in the specific frame section for which the edit command is input is acquired, the display apparatus generates an ES (Elementary Stream) packet that includes a reserved start code that indicates the edit command and the PTS information of the start video frame and the last video frame included in the specific frame section. Thereafter, the display apparatus may generate a PES packet based on the generated ES packet and then may generate the indexing packet in consideration of the generated PES packet as at least one TS (Transport Stream) packet having a preset unit size.

If the indexing packet in the form of a TS packet is generated, the display apparatus inserts an indexing packet that indicates the edit command for the specific frame section onto the transport stream of the corresponding video content. In this case, it is preferable that the display apparatus inserts the indexing packet that indicates the edit command for the specific frame section before the corresponding specific frame section.

As described above, if the indexing packet is inserted before the specific frame section, the display apparatus stores the transport stream of the video content into which the indexing packet is inserted. Accordingly, the display apparatus may store original first video content and second video content (hereinafter referred to as “edited video content”) into which the indexing packet is inserted in relation to the corresponding video content.

Hereinafter, a method for displaying edited video content, into which the indexing packet that indicates the edit command for the specific frame section in the display apparatus is inserted, will be described in detail.

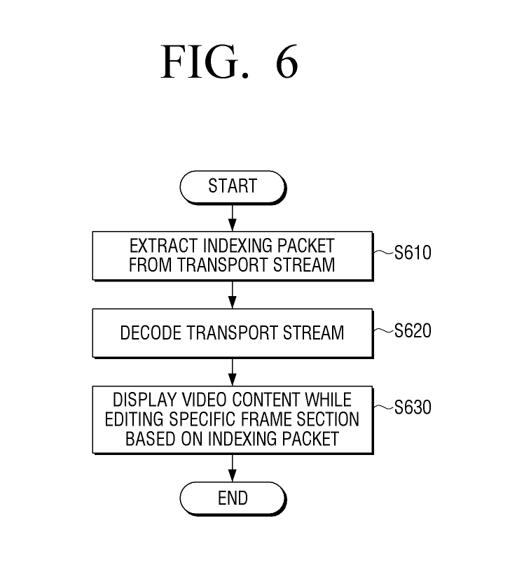

FIG. 6 is a flowchart illustrating a method for displaying video content in which an indexing packet is inserted in a display apparatus according to an embodiment of the present disclosure.

As illustrated in FIG. 6, if a reproduction command for edited video content that is video content into which an indexing packet is inserted is input, the display apparatus extracts the indexing packet that indicates an edit command for a specific frame section based on PES header information of a plurality of video frames temporarily stored in a buffer (not illustrated) (S610) prior to decoding of a transport stream of a corresponding edited video content. Thereafter, the display apparatus decodes the plurality of video frames temporarily stored in the buffer (not illustrated), and reproduces the decoded edited video content while editing the specific frame section based on the pre-extracted indexing packet (S620 and S630).

Specifically, the display apparatus temporarily stores the video frames in the unit of a PES packet constituting the transport stream of the edited video content in the buffer (not illustrated). Here, the transport stream may be a video stream separated through a demux. If the video frame in the unit of a PES packet is temporarily stored in the buffer (not illustrated), the display apparatus determines whether a reserved start code that indicates the edit command is included in the video frame with reference to a PES header of the video frame temporarily stored in the buffer (not illustrated). If the reserved start code is not included as the result of the determination, the display apparatus decodes the corresponding video frame based on PTS information included in the PES header of the video frame that is temporarily stored in the buffer (not illustrated) to display the decoded video frame.

On the other hand, if the reserved start code that indicates the edit command is included in the PES header of one of the plurality of video frames that are temporarily stored in the buffer (not illustrated), the display apparatus determines that the corresponding video frame is the indexing packet that indicates the edit command for the specific frame section. Accordingly, if the indexing packet that indicates the edit command for the specific frame section is detected, the display apparatus acquires start PTS information of a start video frame and end PTS information of a last video frame included in the specific frame section from the detected indexing packet.

Thereafter, the display apparatus determines the video frame having PTS information that corresponds to the start PTS information and the end PTS information as the specific frame section for which the editing operation is performed through comparison of the start PTS information and the end PTS information acquired from the indexing packet with the PTS information extracted from the remaining video frames temporarily stored in the buffer (not illustrated).

As described above, if the specific frame section is determined on the basis of the start PTS information and the end PTS information acquired from the indexing packet, the display apparatus displays the decoded edited video content while editing the specific frame section based on time information of the start video frame and time information of the last video frame included in the specific frame section.

Specifically, if the video frame (hereinafter referred to as the “start video frame”) having the PTS information that corresponds to the start PTS information acquired from the indexing packet is acquired, the display apparatus decodes the corresponding video frame, and then displays the decoded video frame. In this case, the display apparatus continuously displays the start video frame that corresponds to the start PTS information until the last video frame that corresponds to the end PTS information is displayed. Thereafter, if the video frame (hereinafter referred to as the “last video frame”) having the PTS information that corresponds to the end PTS information acquired from the indexing packet, the display apparatus decodes the video frame of the remaining edited video content from the corresponding frame and displays the decoded video frame.

On the other hand, if the start video frame that corresponds to the start PTS information included in the indexing packet is acquired, the display apparatus decodes only the I picture frames of the video frame until the last video frame that corresponds to the end PTS information included in the indexing packet is acquired. That is, the display apparatus decodes the video frame for I picture frames among the video frames until the last video frame that corresponds to the end PTS information is acquired, decodes the video frame for I picture frames and P picture (Predictive picture) frames in the GOP including the end PTS information, and does not decode the video frame for B picture (Bidirectionally predictive picture) frames.

As described above, since the display apparatus decodes only the video frame related to I picture frames among the video frames until the last video frame that corresponds to the end PTS information is acquired, the time, which is required until the last video frame that corresponds to the end PTS information is displayed after the start video frame that corresponds to the start PTS information is displayed, can be minimized, and the blocking phenomenon, which occurs in the process of sequentially displaying the start video frame that corresponds to the start PTS information and the last video frame that corresponds to the end PTS information, can be reduced.

As described above, the present disclosure has been described around the preferred embodiments thereof.

While the present disclosure has been shown and described with reference to certain embodiments thereof, it will be understood by those skilled in the art that various changes in form and detail may be made therein without departing from the spirit and scope of the present disclosure, as defined by the appended claims.

What is claimed is:

1. A method for editing recorded video content in a display apparatus comprising:
receiving an input of an edit command for a specific frame section of the video content;
generating an indexing packet to indicate the edit command for the specific frame section through extraction of information of the specific frame section for which the edit command is input; and
storing a transport stream for the video content, the indexing packet being inserted to the transport stream.

2. The method for editing recorded video content as claimed in claim 1, wherein the generating comprises extracting time information of the specific frame section through acquiring of PTS (Presentation Time Stamp) information of video frames included in the specific frame section for which the edit command is input.

3. The method for editing recorded video content as claimed in claim 2, wherein the generating comprises acquiring the time information of the specific frame section through acquiring of PTS information of a start video frame and PTS information of a last video frame of the video frames included in the specific frame section for which the edit command is input.

4. The method for editing recorded video content as claimed in claim 1, wherein the generating comprises:
generating an ES (Elementary Stream) packet including a reserved start code that indicates the edit command and PTS information of a start video frame and a last video frame included in the specific frame section;
generating a PES (Packetized Elementary Stream) packet based on the ES packet; and
generating the indexing packet in consideration of the PES packet as at least one TS packet having a preset unit size.

5. The method for editing recorded video content as claimed in claim 1, wherein the storing comprises inserting the indexing packet before the specific frame section for which the edit command is input, and then storing the video content in which the indexing packet is inserted.

6. A display apparatus comprising:
a storage configured to store video content;
an input unit configured to receive an input of an edit command for a specific frame section of the video content; and
a controller configured to generate an indexing packet to indicate the edit command for the specific frame section through extraction of information of the specific frame section for which the edit command is input and to store a transport stream for the video content, the indexing packet being inserted to the transport stream.

7. The display apparatus as claimed in claim 6, wherein the controller extracts time information of the specific frame section through acquiring of PTS (Presentation Time Stamp) information of video frames included in the specific frame section for which the edit command is input.

8. The display apparatus as claimed in claim 7, wherein the controller acquires the time information of the specific frame section through acquiring of PTS information of a start video frame and PTS information of a last video frame of the video frames included in the specific frame section for which the edit command is input.

9. The display apparatus as claimed in claim 6, wherein the controller generates an ES (Elementary Stream) packet including a reserved start code that indicates the edit command and PTS information of a start video frame and a last video frame included in the specific frame section,
generates a PES (Packetized Elementary Stream) packet based on the ES packet, and
generates the indexing packet in consideration of the PES packet as at least one TS packet having a preset unit size.

10. The display apparatus as claimed in claim 6, wherein the controller inserts the indexing packet before the specific frame section for which the edit command is input, and
the storage stores the video content in which the indexing packet is inserted.

11. A method for displaying recorded video content in a display apparatus comprising:
decoding a transport stream of video content including an indexing packet that indicates an edit command for a specific frame section of the video content; and
displaying the video content while editing the specific frame section based on the indexing packet.

12. The method for displaying recorded video content as claimed in claim 11, further comprising extracting a packet including a reserved start code that indicates the edit command from the transport stream as the indexing packet before the decoding.

13. The method for displaying recorded video content as claimed in claim 11, wherein the decoding comprises decoding a video frame related to an I-picture (Intra picture) among video frames included in the specific frame section based on PTS information included in the indexing packet.

14. The method for displaying recorded video content as claimed in claim 11, wherein the displaying comprises acquiring time information of a start video frame and time information of a last video frame included in the specific frame section based on PTS information included in the indexing packet, and displaying the video content while editing the specific frame section based on the acquired time information.

15. The method for displaying recorded video content as claimed in claim 14, wherein the displaying comprises displaying the start video frame or a previous video frame included in the specific frame section while editing the specific frame section.

16. A display apparatus for displaying recorded video content comprising:
a decoder configured to decode a transport stream of video content including an indexing packet that indicates an edit command for a specific frame section of the video content;
a display configured to display the decoded video content; and
a controller configured to control the display to display the video content while editing the specific frame section based on the indexing packet.

17. The display apparatus as claimed in claim 16, wherein the controller determines whether there is a packet including a reserved start code that indicates the edit command with reference to headers of packets constituting the transport stream, and then controls the decoder to decode the transport stream of the video content.

18. The display apparatus as claimed in claim 16, wherein the controller controls the decoder to decode a video frame related to an I-picture (Intra picture) among video frames included in the specific frame section based on PTS information included in the indexing packet.

19. The display apparatus as claimed in claim 16, wherein the controller acquires time information of a start video frame and time information of a last video frame included in the specific frame section based on PTS information included in the indexing packet, and controls the display to display the video content while editing the specific frame section based on the acquired time information.

20. The display apparatus as claimed in claim 19, wherein the controller controls the display to display the start video frame or a previous video frame included in the specific frame section while editing the specific frame section.
